(19) United States
(12) Patent Application Publication
(10) Pub. No.: US 2019/0236620 A1
(43) Pub. Date: Aug. 1, 2019

(54) Sales Opportunity Management for Agency Models

(71) Applicants: Paul Knight, Spokane, WA (US); Sam Fleming, Spokane, WA (US)

(72) Inventors: Paul Knight, Spokane, WA (US); Sam Fleming, Spokane, WA (US)

(73) Assignee: Dark Capital, Inc., Spokane, WA (US)

(21) Appl. No.: 16/258,632

(22) Filed: Jan. 27, 2019

Related U.S. Application Data
(60) Provisional application No. 62/624,792, filed on Jan. 31, 2018.

(51) Int. Cl. G06Q 30/02; G06Q 10/06

(52) U.S. Cl. CPC G06Q 30/0202; G06Q 30/0252; G06Q 10/0631

(57) ABSTRACT

A sales opportunity delivery and routing system is described. Sales opportunities are created by independent companies that are competing for the same customers. The independent companies also use common sales agencies for converting sales opportunities into wins and losses. The independent sales agencies provide the companies sales goals showing they desire to sell opportunities with particular attributes. The sales opportunities are aggregated to create known sales demand from the sellers. Once a sales opportunity is created it is routed to the one or more sellers. The resulting sales activities create variable feedback to the one or more companies based upon each company's role in the opportunity.

### CROSS REFERENCE TO RELATED APPLICATION

This application claims the benefit of pending U.S. provisional application Ser. No. 62/624,792 filed Jan. 31, 2018 by the present inventors, which is incorporated by reference in its entirety.

### STATEMENT REGARDING FEDERALLY SPONSORED R&D

Not related to this application.

### TECHNICAL FIELD

The present invention is directed at computerized sales management systems, and more particularly to a computerized sales management system used by multiple competing companies that do business with common, yet independently owned, sales agencies.

### BACKGROUND OF THE INVENTION

The process of selling is well known in the art of business. Traditionally, a seller identifies a sales prospect and engages the prospects with sales activities, such as phone calls, letters, and face-to-face meetings. The goal of the seller is to educate and entice the prospect to buy a good or a service. Marketing and advertising are often done prior to selling as to generate interest and to identify prospects for sellers. The prospects are then delivered to sales people as leads. Some industries, such as retail shopping, relies more on marketing than direct sales people. But most industries that require a considered decision of a buyer still rely on salespeople to provide information and motivation for converting prospects into customers.

Today's selling process is heavily influenced by technology. Due to the ease of sending emails and digital communications, contacts and customers are inundated with offers and activities from businesses. The result is that it has become increasingly difficult for companies to find and engage potential customers and generate sales leads. Corporations and companies invest tremendous amounts of money into advertising and marketing, with the goal to ultimately create opportunities to sell engaged prospects. A known opportunity to sell can be of significant value and technology can help manage the large quantities of opportunities that a corporation may create. Customer Relationship Management Systems, or commonly referred to as “CRM” systems are used by most of today's businesses to manage these opportunities. CRM systems allow a seller, or marketing team, to create contacts records of potential buyers and to market different products and services to them. Once a known opportunity to sell is created, an opportunity in the CRM system is generated. The opportunity may be assigned to a sales person wherein they perform and record sales activities in the CRM system. Some CRM systems provide automated marketing programs to help sellers systematically engage prospects and customers. CRM systems generate large amounts of data which can be aggregated into reports for management. Management may utilize this data for understanding their sales pipeline and seller performance.

Today's CRM systems are designed for traditional businesses that utilize a direct sales force. In a direct sales force, a seller is hired and paid a wage to sell the products and services of a particular company. Each sales person in the company is given a user account, within a company account, in the CRM system and each seller may be assigned contacts to sell to. As the seller performs sales and marketing activities, data is generated. Based upon the data, a high performing seller can be identified and rewarded, and conversely a poor performing sales person can be identified for additional training. Knowing prospects, leads, and opportunities are extremely valuable, it is the job of management to use the CRM data to maximize return on their marketing investment. Today's CRM systems may reside on a company server “on-premise” or may be a hosted multi-tenant “cloud” architecture wherein multiple companies may use the same software with data isolated by company accounts. Regardless if the CRM system is on-premise or a multi-account cloud based solution, today's CRM systems have user permissions that follow the general structure of a company. A seller may see their own data, but may not be able to see the data of their peers. The CRM system may aggregate the data of a group of sellers for their manager. A territory or divisional manager may see the aggregated data of the sellers that work in their group. Ultimately, a CEO or president may see the aggregated data of all the sellers that work for the company. Anywhere in the hierarchy of the organization, a manager or leader may review their data and drive improvements. In the direct sales model, marketing dollars generate sales opportunities that the company can directly control. Today's CRM systems are designed for traditional companies that have their own sales employees.

In some industries, such as insurance products and financial services, corporations utilize agencies to engage with prospects and customers. These agencies are separate legal entities and the corporation cannot dictate the business practices of the agency. An agency owner may have an affiliation with one or more corporations or carriers and choose which company to promote to a particular prospect. In the case of independent insurance agencies, the agency may have affiliations with dozens of different carriers. Carriers market to prospects through television, radio, newspaper and billboard advertisements in hopes to create brand awareness and to separate themselves from other carriers. The carriers rely on the insurance agencies to generate sales leads and opportunities, with the marketing of the carrier influencing the final sale.

Given today's inundated consumer and the fact most agencies do not have the marketing expertise to generate their own sales prospects and opportunities, carriers are increasingly generating sales leads and delivering them to agencies to sell. Because agencies operate as separate legal entities and represent multiple carriers, agencies use their own CRM system as they do not want to provide all their data to others. Agencies need to operate like traditional business within a CRM system, with top down access to data. The resulting challenge occurs when a carrier creates a sales opportunity via their own marketing investment, delivers it to an agency via email, and then that agency ultimately sells a product from a competing carrier. There is no way for the carrier to know what happened to the lead they generated unless the sale is quoted or won. A carrier may implement a bulk sales quota, or create a sales incentive, for an agency to try to influence the agency to sell more of their own products and services. But unlike a traditional company, the carrier does not have visibility to the direct actions of a seller for particular opportunities. The carrier does not have access to the data to know if their marketing investment is converting wins for themselves or a competitor is reaping the benefits. The carrier does not know how to optimize their marketing to generate opportunities with higher win probabilities. The carrier does not have access to the data to know which sellers, or agencies, are motivated to sell certain products. The carrier does not have access to the data to know which sales activities are more likely to generate sales wins.

Today, corporations that use agency sales models are at a distinct disadvantage to corporations that utilize a direct sales model. The lack of data sharing between corporation and agency results in inefficient marketing investments and slow process improvements. With the recent expansion of machining learning that leverages data for process improvement, the gap is expected to widen between independent agency sales models and traditional direct models.

The present invention is directed at, but not limited to, improving the marketing and selling performances of distributed agency based models. The present invention allows for an ecosystem approach to data where companies and agencies work in both their own best interest and the best interest of the collective.

### BRIEF DESCRIPTION OF THE DRAWINGS

Preferred embodiments of the invention are described below with the reference to the following accompanying drawings:

FIG. 1 is flow diagram showing how a seller creates activity to a sales contact based upon a known sales opportunity.

FIG. 2 is a flow diagram showing how a client device, a server device, and a network comprise the system and accomplish the methods of the present invention.

FIG. 3 is a flow diagram showing how the server of FIG. 2 delivers an activity to a sales contact and receives feedback on that activity.

FIG. 4 is a flow diagram showing how one or more companies deliver an opportunity to a seller, or agency, within its agency based sales model.

FIG. 5 is a diagram showing an opportunity record within an opportunity database, and the opportunity record having a plurality of opportunity attributes.

FIG. 6 is a diagram showing a goal record within a goal database, and the goal record having a plurality of goal attributes.

FIG. 7 is a diagram showing a contact record within a contact database, and the contact record having a plurality of contact attributes.

FIG. 8 is a diagram showing an activity record within an activity database, and the activity record having a plurality of activity attributes.

FIG. 9 is a flow diagram showing example sources for delivering new sales opportunities to the system of the present invention.

FIG. 10 is a flow diagram showing the connection between goals, opportunities and activities within the system of the present invention.

FIG. 11 is a flow diagram showing how one or more sellers within the system of the present invention create goals that can be used to create forecasts, financial plans and marketing plans.

FIG. 12 is a flow diagram showing how a company can use feedback to create a marketing plan for delivering content to a contact for creating sales opportunities.

FIG. 13 is a flow diagram showing how a seller within the system of the present invention can convert an opportunity into activity through the use of a marketing program.

FIG. 14 is a flow diagram showing how a machine learning engine with the present invention can automatically turn sales opportunities into a marketing program and activity directed to a contact.

FIG. 15 is a flow diagram showing how the results of seller and marketing activity can be stored as history data and delivered in different amounts to different companies.

FIG. 16 is a diagram showing an example opportunity screen for allowing a user of the present invention to subscribe to one or more opportunity sources.

FIG. 17 is a diagram showing a goal, and associated opportunities, for a user within the present invention.

FIG. 18 is a diagram showing an example screen for a seller dashboard to display goals, opportunities and activities for a particular seller or group of sellers.

FIG. 19 is a diagram showing an example contact screen for allowing a user within the present invention to apply a marketing program to a particular contact.

FIG. 20 is a diagram showing an example marketing program screen for allowing a user within the present invention to create and edit a marketing program.

### SUMMARY OF THE INVENTION

The present invention takes a very different approach to coordinating and optimizing marketing and sales efforts in agency based sales models.

The present invention is a software system for managing sales prospects, marketing activities, sales activities and sales opportunities. Data is exchanged in a controlled way between corporations and affiliated independent agencies.

The present invention is a software system comprised of a server system communicating with one or more client devices. Together, the software system and client device provide the novel methods and processes used to create the objects of the invention.

An object of the present invention is to enable sellers, or workgroups of sellers, to create sales goals that have attributes which can be shared with affiliated corporations. The corporations can utilize the sales goals to inform their marketing strategy and to generate relevant sales opportunities.

An object of the present invention to enable carriers to deliver sales opportunities to sellers and agencies that have sales goals that align with the attributes of a generated opportunity.

An object of the present invention is to consolidate the goals of sellers and agency workgroups into a financial forecast to help carriers determine the marketing investment needed to accomplish a sales forecast.

An object of the present invention is to enable carriers, or corporations, to provide marketing content and activity support to sellers as they attempt to convert prospects into customers.

An object of the present invention is to deliver agency data back to a carrier for a particular sales opportunity in which that carrier generated.

An object of the present invention is to deliver some agency data back to a carrier that won an opportunity but did not create the opportunity.

An object of the present invention is to deliver an amount of agency data back to a carrier that did not win an opportunity and also did not generate the opportunity.

These and other features, aspects, and advantages of the present invention will become better understood with regard to the following description, appended claims, and accompanying drawings.

### DETAILED DESCRIPTION OF THE PREFERRED EMBODIMENTS

Some of the general components utilized in this invention are widely known and used in the field of the invention, and their exact nature or type is not necessary for a person of ordinary skill in the art or science to understand the invention; therefore, they will not be discussed in detail. It is appreciated that components of networks, network transmission, the internet, databases and software as a service, are well known in the art of software and thus their exact features are not needed for one to understand and practice the invention without undue experimentation, and thus will not be described in detail.

As used herein, the term “company” is intended to indicate a corporation that has a product or service they wish to sell through a network of independently owned and operated agencies. A company may be, but is not limited to, a carrier in the insurance industry. Within the software system of the present invention a company has a system account that isolates its data. Users may have user accounts directly associated to a system account.

As used herein, the term “agency” is intended to indicate an independently owned business entity which may sell the products and services of one or more companies. An agency may be, but is not limited to, an independent insurance agency. Within the software system of the present invention an agency has a system account that protects the agency data and provides traditional top down reporting. Agency users may have user accounts directly associated to the agency system account.

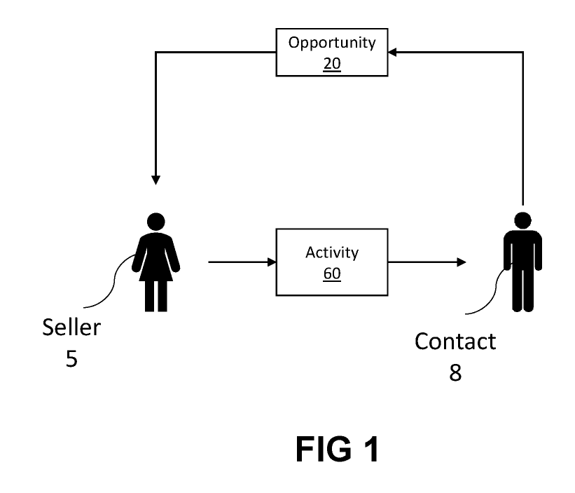

As shown in FIG. 1 and used for describing the highest-level process of selling, a seller 5 has an opportunity 20 to sell a product or service to a contact 8. Seller 5 performs activity 60 in response to opportunity 20. Activity 60 may be, but is not limited to, a phone call, text message, meeting, mailing, and email. An opportunity sales win may require seller 5 to perform multiple different sequential activities over time as part of a sales cycle.

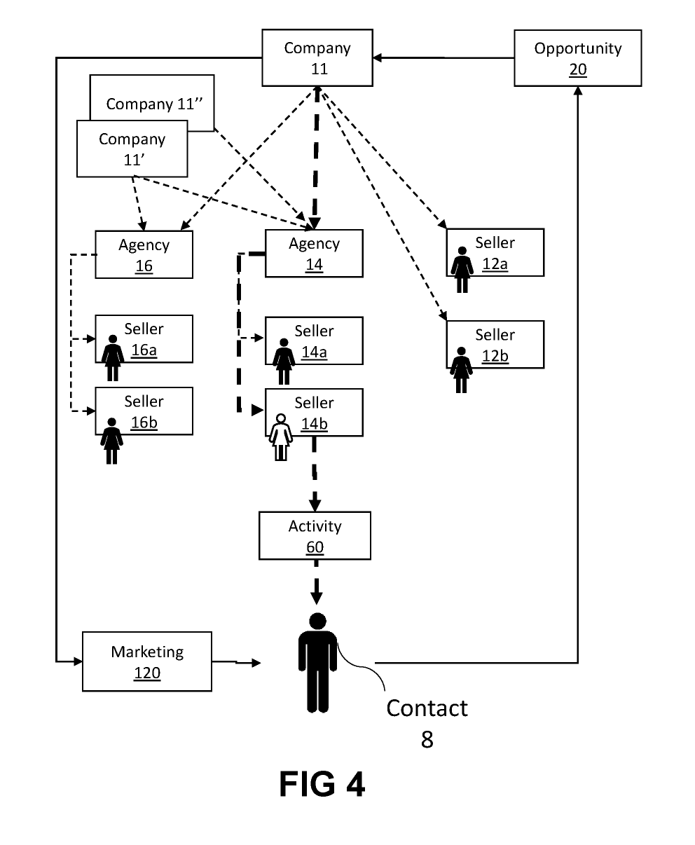

Agency based sales models are described in FIG. 4. A company 11 performs one or more marketing activities as part of a marketing plan 120 directed to contact 8. Marketing plan 120, and resulting marketing activities, may be directed at a group of potential consumers which includes contact 8. The goal of company 11 is to create opportunity 20 which represents data about a product or service that is of likely interest to contact 8. Utilizing technology, company 11 may acquire opportunity 20 by means of its website, an application, kiosk form, analyzing its own customer data, and such. Company 11 routes opportunity 20 to one or more of its affiliated agencies or sellers. An agency 16 may be comprised of a seller 16a and a seller 16b. An agency 14 may be comprised of a seller 14a and a seller 14b. Company 11 may also have a direct employee seller 12a and 12b. As shown and given attribute data about opportunity 20, seller 14b may have the greatest likelihood of creating a sale for company 11. Ideally, and through technology, company 11 routes opportunity 20 to seller 14b so that seller 14b can create activity 60 to contact 8. In the case of an independent agency sales model, a company 11′ is also trying to market to contact 8 and generate opportunities to deliver to its network of agencies, many of which also sell the products of company 11. It should be appreciated that independent agency sales models are complex, and often an opportunity to sell a product generated by a given company can result in a sale of a competitor's product due to utilizing common sellers. It is desirable for both company 11 and company 11′ to route their own opportunities to sellers that have the best chance of not only winning a sale, but also to sell their own respective products.

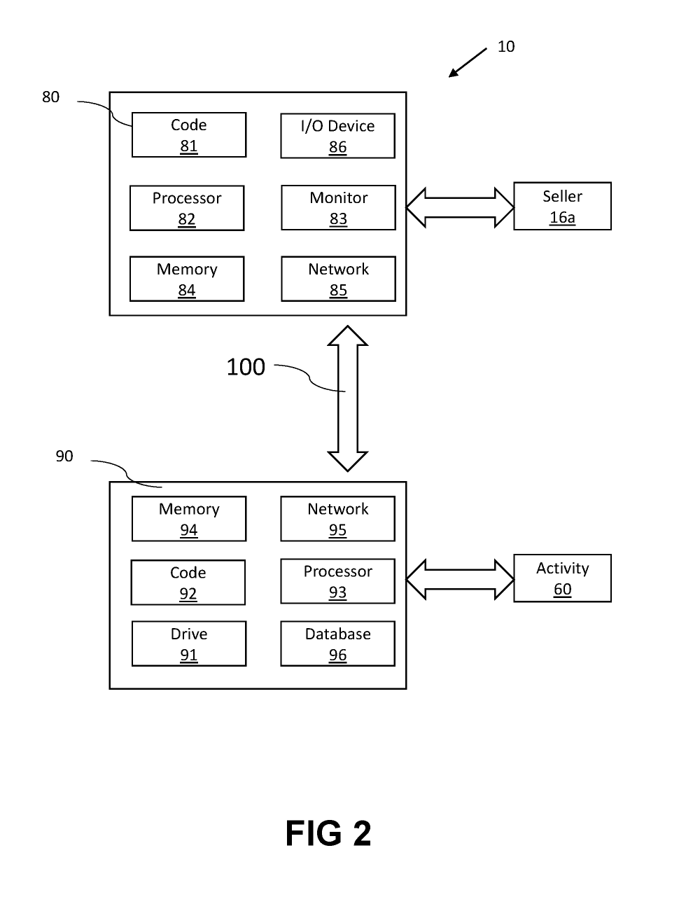

The present invention utilizes technology for creating and routing opportunities to sellers or agencies. A selling system 10 is comprised of a client device 80 that communicates over a network 100, such as the internet, to a server device 90. In the instance of FIG. 2, seller 16a interacts with client device 80 which may be any common electronic system, such as but not limited to a desktop computer, tablet or mobile phone. Client device 80 includes an amount of computer code 81 which may be an application written in any common programming language, such as PHP or Java. Code 81 instructs a processor 82 to transform information from seller 16a into data stored in an amount of memory 84 or to transfer the data across network 100 via a network card 85. Network card 85 contains a unique identifier, such as a MAC address. Seller 16a can interact with client device 80 by means of a monitor 83 and an I/O device 86. I/O device 86 may be a mouse, keyboard, touchpad or any common device for providing instruction back to processor 82. Client devices are well known in the art of computing and networks for allowing a user to provide input to a computer for performing specific instructions according to an amount of computer code. More detail is not needed for one skilled in the art to practice the invention without undue experimentation.

Server device 90 is any common computing or server system capable of processing an amount of server code 92 by a server processor 93. Server device 90 is comprised, but not limited to, a sever network card 95 also containing a unique identifier such as a MAC address, for sending and receiving information and data from client device 80. Server processor 93 transforms and controls data that may be placed into an amount of server memory 94 or into a drive 91 containing a database 96. Database 96 may be a SQL based system, or an unstructured no-SQL type system common in the art of computers. Server 90 may simultaneously communicate with many different client devices. Server 90 provides the means of transforming data for coordinating efforts of multiple sellers utilizing unique client devices.

It should be appreciated that databases, networks and computers are common in the art of technology, business and software and that the exact method of transforming data by means of computer code and computers is not needed for one to practice the present invention. It should also be appreciated that a single server may be used, or alternatively a plurality of servers may provide individual functions to create the overall function described for server device 90.

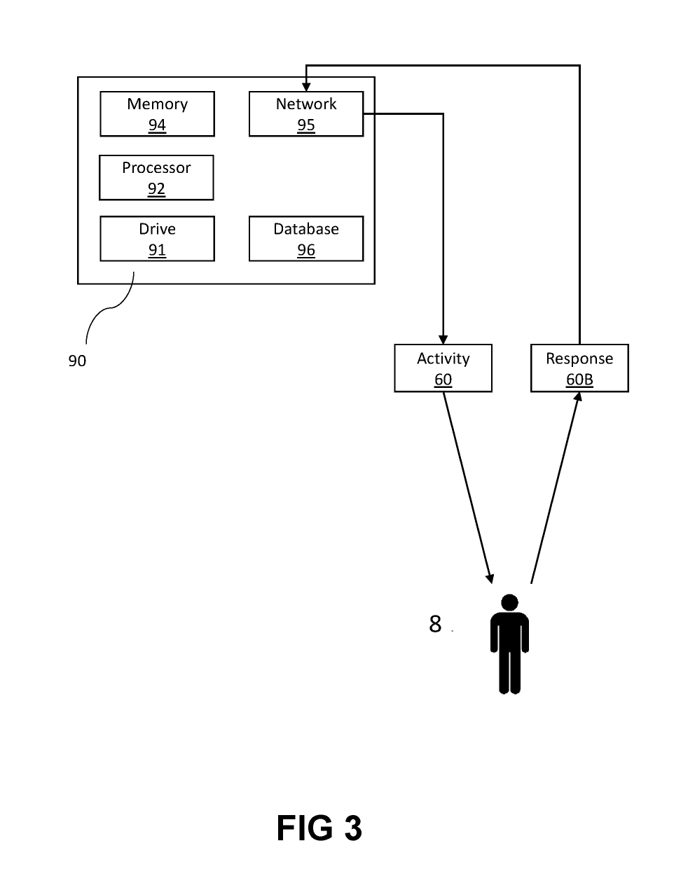

As shown in FIG. 3, server device 90 may not only store information, and exchange information with client device 80, but can deliver information to consumer 8 represented by activity 60. Marketing automation is common in the art of business, marketing and selling. Although seller 16a may personally deliver activity 60 in the event it is a phone call or meeting, server device 90 may deliver activity 60 to consumer 8 in the event it is a recorded voice mail, social message, email or text message. Server 90 may also deliver activity 60 through an API to a third-party service. As is common with many electronic activities, a response 60B may be delivered back to server device 90 in response to the actions of contact 8. Response 60B may be a delivery receipt by another computer, an open notification of an email, or a delivery notification of physical mail.

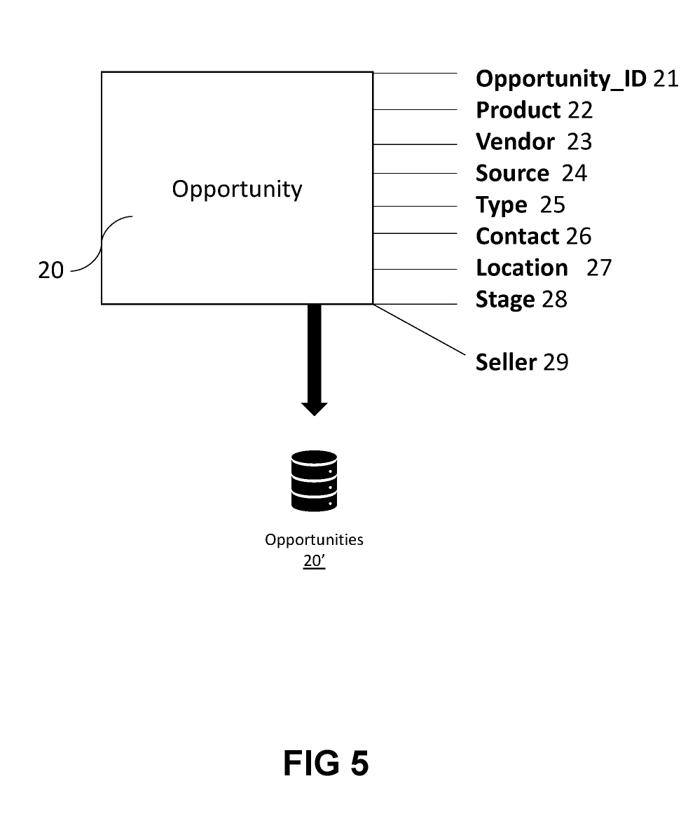

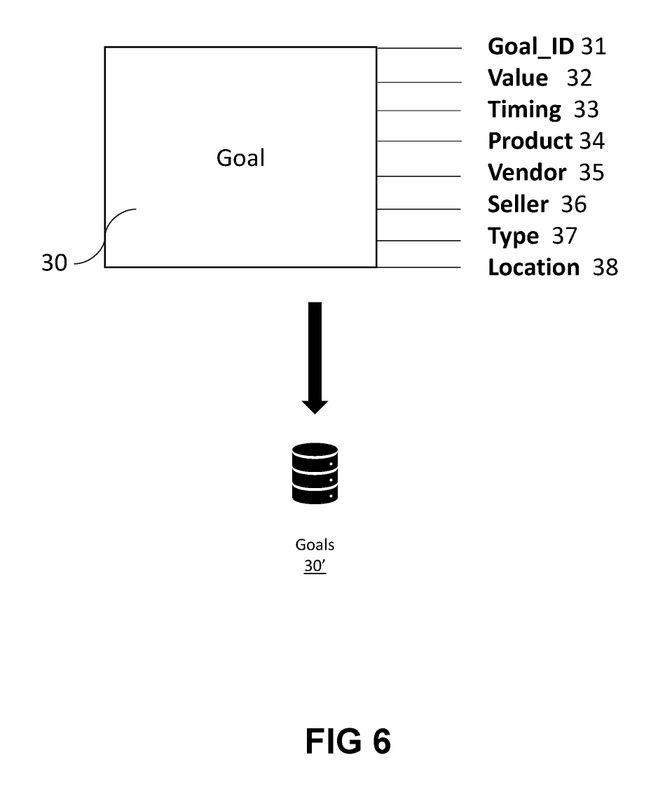

As shown in FIGS. 5-8, database 96 contains data having attributes that may be structured in separate databases, tables, rows and/or records. The following descriptions of data elements is given in the context of a traditional relational database, however it should be appreciated that other methods of storing, retrieving and storing data may be used. An opportunity table 20′ contains a collection of unique opportunities, which describe an opportunity for a seller to sell one or more products to a customer. Opportunity 20 is represented by attributes comprised of an opportunity ID 21, that may be a primary key or index for optimizing retrieval of individual opportunity records. Opportunity 20 is also comprised of a product attribute 22 which corresponds to the actual product the consumer is interested in, or the product category (line-of-business), such as auto insurance, life insurance or retirement products. A vendor attribute 23 represents the vendor company associated to the opportunity, such as the name of company 11 or company 11′. A source attribute 24 represents where the opportunity came from, such as a corporate website, social media site or purchased data. A type attribute 25 describes the type of opportunity, for example a new customer, or in the case of selling insurance an opportunity to cross-sell an existing customer to another type of insurance. Opportunity 20 is also comprised of a stage attribute 28 which describes where opportunity 20 resides in a typical sales cycle. For example, stage attribute 28 may be “cold lead”, “engaged”, “discovery”, “quoting”, “won” or “lost”. Opportunity 20 also is comprised of a contact attribute 26 which indicates the person or business that opportunity 20 is intended to be sold to. Opportunity 20 may have a seller attribute 29 that represents which seller, company or workgroup in system 10 opportunity 20 is being actively worked by. Other attributes of opportunity 20 may exists, for example and in the case of selling insurance a location attribute 27 which represents the address of the property to be insured or data about the product to be insured. The one or more attributes that describe opportunity 20 are used within the present invention for associating opportunity 20 to other data and parts of system 10.

A goals table 30′ is comprised of rows, or records, of goals. A goal 30 can be created by an individual seller or provided to a seller by a person or group higher in the organizational hierarchy (such as agency owner, region or carrier). The purpose of goal 30 is to provide motivation and accountability for seller to do activity and generate sales wins. Like opportunity 20, goal 30 is comprised of numerous descriptive attributes for allowing it to be linked to other data and parts within system 10. A goal ID 31 may be a primary auto-incrementing key and used for facilitating retrieval of goal records. A value attribute 32 is used for describing the desired outcome of goal 30 which may be a total count of sales, a dollar amount of sales, or in the example of insurance, contain policy wins, premium or seller commissions. Goal 30 also is comprised of a timing attribute 33 that contains the starting date and ending date of goal 30. Goal 30 also contains a product attribute 34 which indicates the type of product, or product line goal 30 is to measure. According to the present invention, product attribute 34 can be connected to the data of opportunity product attribute 22 to connect opportunities to goals with respect to product types. Goal 30 also is comprised of a vendor attribute 35 which describes the company the goal may be associated to. According to the present invention, goal attribute 35 can be connected to the data of opportunity vendor attribute 23 to connect opportunities to goals with respect to companies. Goal 30 contains a seller attribute 36 which can be used to associate a user, or group of users, within system 10 to goal 30. Goal 30 may contain a type attribute 37 which describes the type of goal, for example, if it is to acquire new business, retain a customer, or cross-sell. Goal 30 may contain a location attribute 38 which describes the geographic location of goal 30. Attributes of goal 30 provide the means to associate it with opportunity 20.

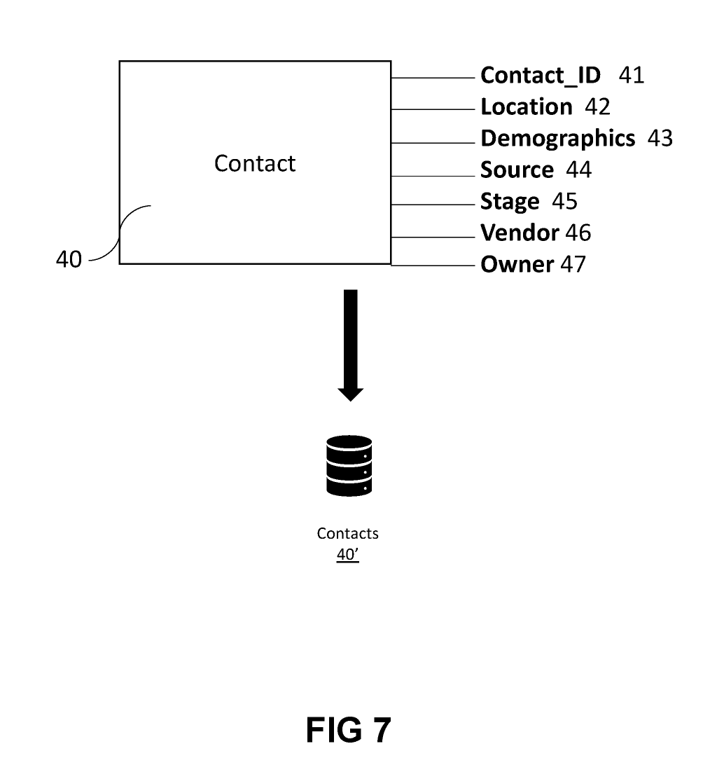

As shown in FIG. 7, a contact table 40′ contains one or more records. A contact record 40 includes attributes, or fields, that allow it to be associated with other data records and parts within system 10. Contact record 40 may include a contact ID 41 which is an auto-incrementing primary key for facilitating data retrieval. Contact record 40 may be comprised of a location attribute 42 for describing the geographical location of the person, or business, described by contact record 40. Contact record 40 may include one or more demographic attribute 43 for describing the individual characteristics of the person, or business, described by contact record 40. A source attribute 44 may describe where contact record 40 was initiated, such as a referral, web site or the such. A vendor attribute 46 may describe which vendor company contact 40 is associated to. Contact record 40 may be comprised of an owner attribute 47 for indicating which seller, or agency, in system 10 that owns the relationship with contact 8. Contact record 40 is comprised of numerous descriptive attributes for allowing it to be linked to other data and parts within system 10.

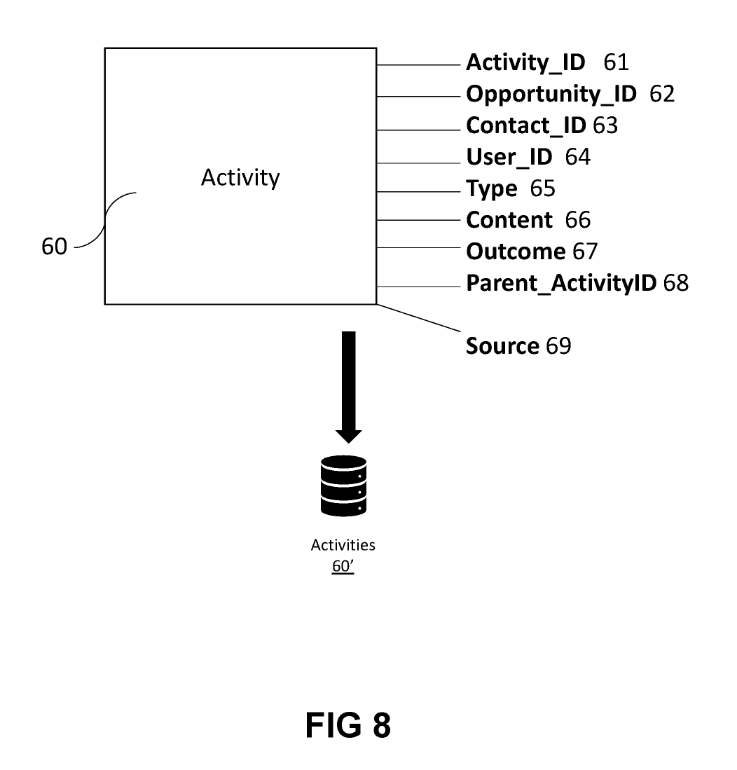

As shown in FIG. 8, an activity table 60′ contains one or more records. Activity 60 includes attributes, or fields, that allow it to be associated with other data records and parts within system 10. An activity ID 61 may be an auto indexing primary key to allow individual records to be retrieved. Activity 60 may be comprised of an opportunity ID 62 for allowing activity 60 to be directly associated with opportunity ID 21 of opportunity 20. Activity 60 may be comprised of a contact ID 63 for allowing activity 60 to be directly associated with contact ID 41 of contact record 40. Activity 60 may be comprised of a user ID 63 for allowing activity 60 to be directly associated to seller 5, or the person (or workgroup) initiating the activity. Activity 60 may be comprised of a type 65 for describing which type of activity is being delivered. For instance, type 65 attribute may be an email, voice, mail, SMS message, and the such. Activity 60 may be comprised of a content 66 attribute for containing or identifying the information to be delivered to contact 8. For instance, if activity 60 is an e-mail, content 66 may be text. In the event activity 60 is direct mail, content 66 may be a visual image. In the event activity 60 is a phone call, content 66 may be a call script. Activity 60 may also be comprised of an outcome 67 attribute for describing response 60B. Activity 60 may be comprised of a parent activity ID 68 attribute for associating activity 60 to a preceding activity within activity table 60′. In the event that marketing automation is used, activity 60 may be comprised of a source 69 attribute for associating activity 60 to a particular marketing program 121. Activity 60 may include a schedule value for the date and time which activity it is to be delivered to contact 8.

It should be appreciated that while the above attribute descriptions are part of the best mode of the present invention, the descriptions are provided to show how data within opportunity table 20′, goal table 30′, contact table 40′ and activity table 60′ may be connected. An object of the present invention is to allow opportunities to be routed to sellers, or agencies, that have a matching goal by means of matching attributes. It is an object of the present invention to allow goals to create a forecast, or a quantifiable need, of opportunities based upon aggregated and segmented attributes. It is an object of the present invention to allow activity to be attached to opportunities to provide an activity history of a particular opportunity or group of opportunities. The activity history can be segmented and delivered to the vendor or source of the opportunity to allow them to better understand their own sales pipeline. It is an object of the present invention to understand what combinations, or sequences of activities, deliver optimal results for a given number of attributes, such as source, vendor, location, product etc.

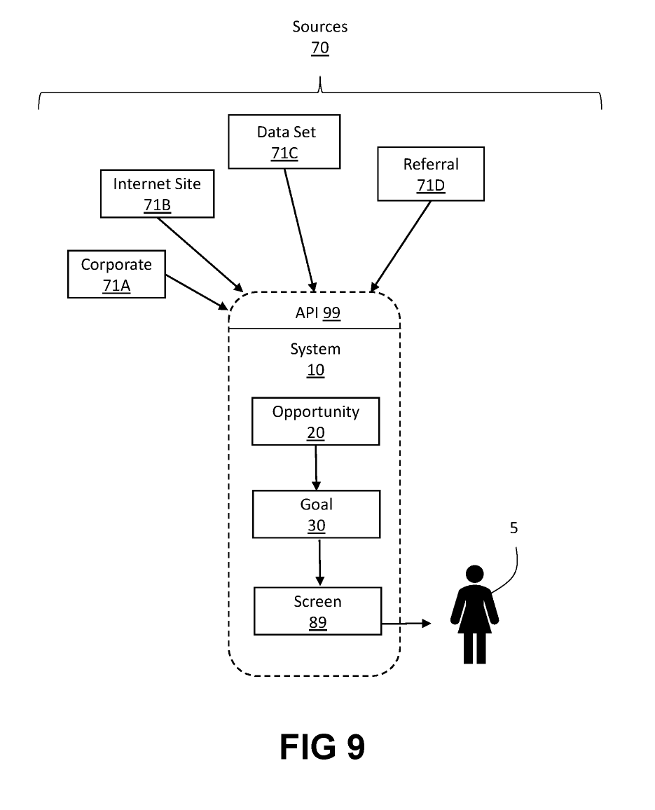

FIG. 9 shows how opportunity 20 is delivered from sources 70 to system 10, and ultimately to seller 5. System 10 may receive opportunity 20 utilizing data objects, such as JSON or XML, through an application program interface 99 (API). An API endpoint may be provided to sources 70 to enable opportunity data to be correctly processed by server 90. Examples of opportunity sources 70 are shown.

A corporate opportunity source 71A may be generated by company 11 or 11′, or yet another company 11″, with the goal of delivering opportunity 20 to an optimal seller, or agency. According to the present invention, seller 5 has goal 30 which contains a vendor attribute 35 that matches vendor attribute 23 of opportunity 20. Company 11 may deliver opportunity 20 to sellers or agencies that are approved to sell company 11 products within system 10.

An internet site source 71B may generate opportunity 20 by advertising to shoppers on the internet. Seller 5 may purchase a subscription with internet site source 71B so that when opportunity 20 is created it includes the value for source attribute 24 and the value of seller 5. Opportunity 20 may contain product attribute 22 which seller 5 has configured goal 30 to include a corresponding product attribute 34. Alternatively, opportunity 20 may contain location attribute 27 with a value corresponding to location attribute 38 of goal 30.

A data set 71C may generate opportunity 20. For example, data set 71C may be a list of contacts that have recently moved, or are preparing to move, and are likely to need new home owner's insurance. Data set 71C may be an uploaded list into system 10, or delivered by means of an API 99. Opportunity 20 is routed to seller 5 by means of one or more attributes 22-29 of opportunity 20 matching corresponding attributes 32-38 of goal 30.

Yet another example is a referral source 71D which may include an email asking an existing customer to recommend a new contact. The existing customer may create data that delivers opportunity 20 to system 10. Opportunity 20 is routed to seller 5 by means of populating seller attribute 29 with the owner attribute 47 of the existing customer record.

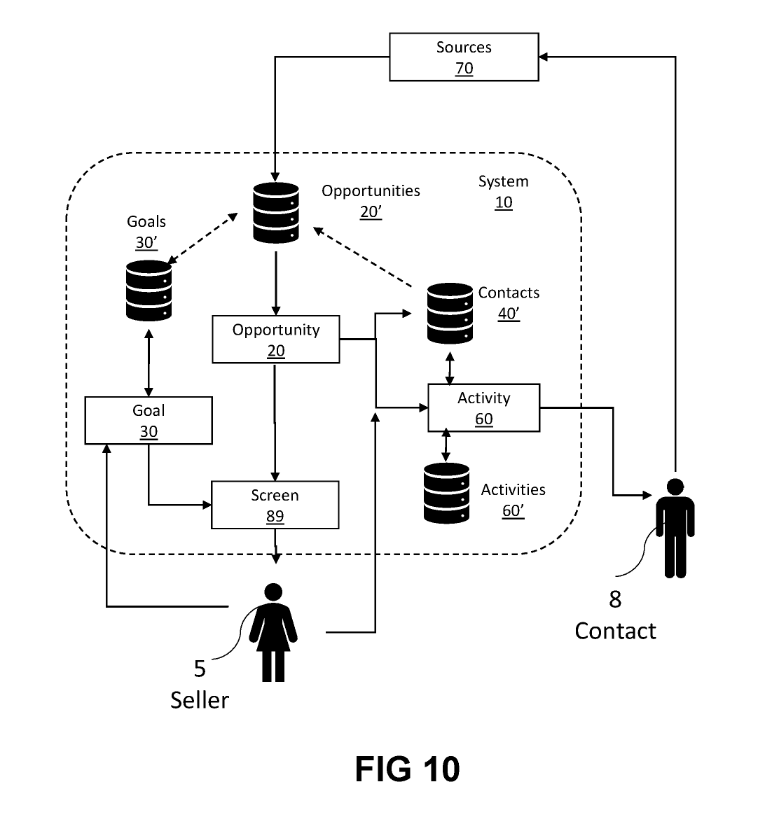

FIG. 10 provides more detail of system 10. As previously described, opportunity 20 for contact 8 is delivered to system 10 via sources 70. System 10 creates opportunity 20 within opportunity table 20′. System 10 looks to identify if an existing contact record exists within contact table 40′ for the contact of opportunity 20, and system 10 creates new contact record 40 if a matching record is not found. Contact ID 41 is placed as contact attribute 26 for opportunity 20 as to join opportunity 20 with contact record 40. Prior to routing opportunity 20, seller 5 creates goal 30 within system 10 via screen 89. Upon creation of opportunity 20, system 10 checks to see if one or more attributes of opportunity 20 matches one or more attributes of a record within goal table 30′. As a first example, if seller 5 has created a goal having a vendor attribute 35 and it matches vendor attribute 23 of goal 20, then system 10 may be instructed through code 92 to be allowed to deliver opportunity to seller 5, or an agency (workgroup) that contains seller 5. As a second example, if seller 5 has created a goal having a product attribute 34 that matches product attribute 22 of opportunity 20, then system 10 may be instructed to be allowed to deliver opportunity 20 to seller 5. It should be appreciated that by matching attributes of records within goal table 30′ to attributes of opportunity 20, opportunity 20 can be optimally delivered to one or more sellers, or agencies of sellers. Preferably, and according to the present invention, opportunity 20 will be delivered to sellers that have one or more goals that correspond to the company, or carrier, that created the opportunity and the product of interest. The present invention provides incentive for sellers to create goals and for companies to deliver opportunities to sellers that want to sell them. Once opportunity 20 is presented to seller 5 though screen 89, seller 5 may create activity record 60 to be delivered to contact 8.

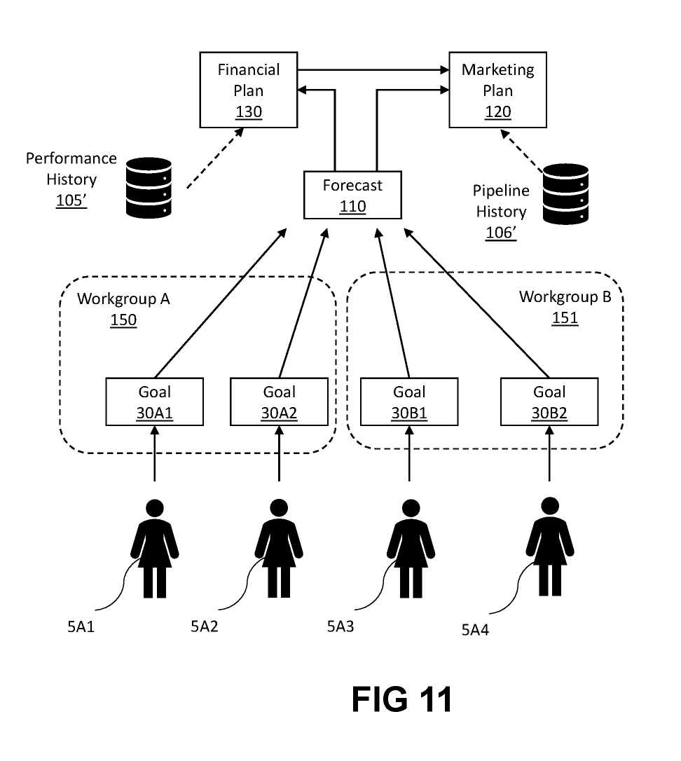

The present invention not only allows optimal delivery of opportunity 20, it also provides insight into the need of opportunity 20 to support one or more goals of sellers. FIG. 11 shows how the goals of one or more sellers can be used to create a financial plan 130 and a marketing plan 120 for a given vendor such as company 11. A first workgroup 150, which may be an agency, division or region, is comprised of a seller 5A1 and a seller 5A2. Seller 5A1 may have a plurality of goals including a goal 30A1 having attributes as previously described. Seller 30A2 may have a plurality of goals including a goal 30A2. Goals 30A1 and 30A2 may be aggregated and segmented by the attributes of each into a forecast 110. Similarly, a second workgroup 151 may be comprised of a seller 5B1 having a goal 30B1 and a seller 5B2 having a goal 30B2B. Goals 30B1 and 30B2 are rolled up, based upon their attributes, into forecast 110 for company 11. For instance, forecast 110 may include all policies intended to be sold for a given geographical value matching location attribute 38 and for a given type of product matching product attribute 34. Alternatively, forecast 110 may include the total number of policies intended to be sold utilizing a given type value matching type attribute 37. Attributes of goal table 30′ provide the means to create financial plan 130 and marketing plan 120 for company 11. Financial plan 130 may be adjusted based upon a performance history 105′. Performance history 105′ may provide a scalar value to apply to goal 30 based upon the historical performance of seller 5. For instance, if seller 5 always fails to meet his/her goals, their contribution to financial plan 130 may be discounted or increased to reflect a more likely outcome. Marketing plan 120, comprised of the total need of opportunities needed to support the aggregated amount of goals of sellers for company 11, may be calculated using a pipeline history 106′. Pipeline history 106′ is comprised of sales cycle information, such as the number of opportunities that make it from one stage to the next. For example, pipeline history 106′ may inform marketing plan 120, that for a given win value within forecast 110 for a given product attribute 22, that nine times that value must be generated as new opportunities.

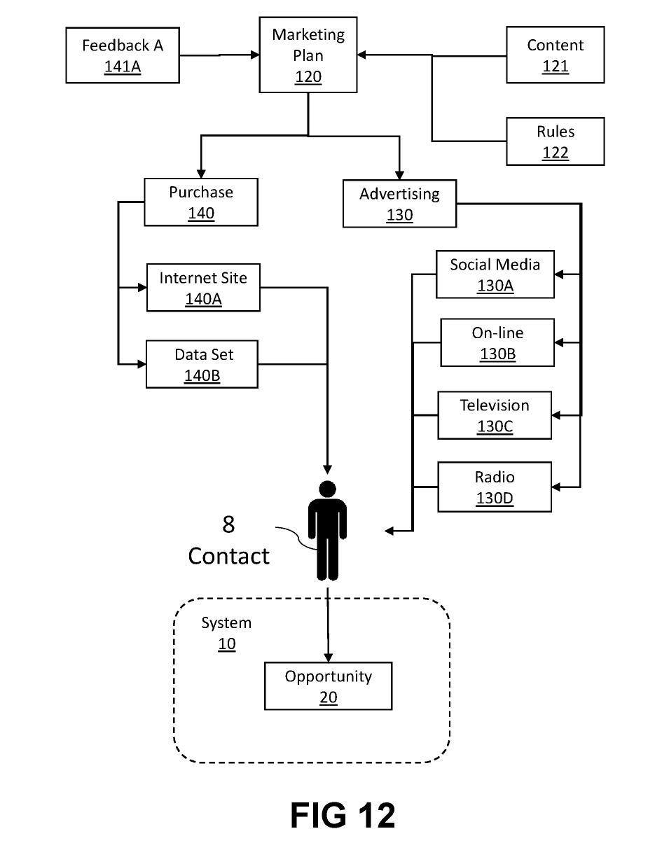

FIG. 12 shows how marketing plan 120 may be used by company 11 to optimally create sufficient opportunities to support their network of agencies based upon the goals of those agencies. Marketing plan 120 is used by company 11 to perform a purchase step 140 to acquire opportunities from third party sources. Purchase step 140 may to subscribe to an external internet site 140A, or to purchase a dataset 140B. Another option for company 11 is to perform an advertising step 130 utilizing a social media channel 130A, an on-line search ad 130B, a television advertisement 130C or a radio commercial 130D to generate interest from a targeted group of people. As previously described, contact 8 is identified and opportunity 20 is created in system 10. Opportunity 20 is then routed to one or more sellers, or agencies, having goal attributes 31-38. With marketing plan 120 comprised of matching attributes of goals within goal table 30′, company 11 may optimally execute its advertising and to accurately predict the return on investment of performing such activities.

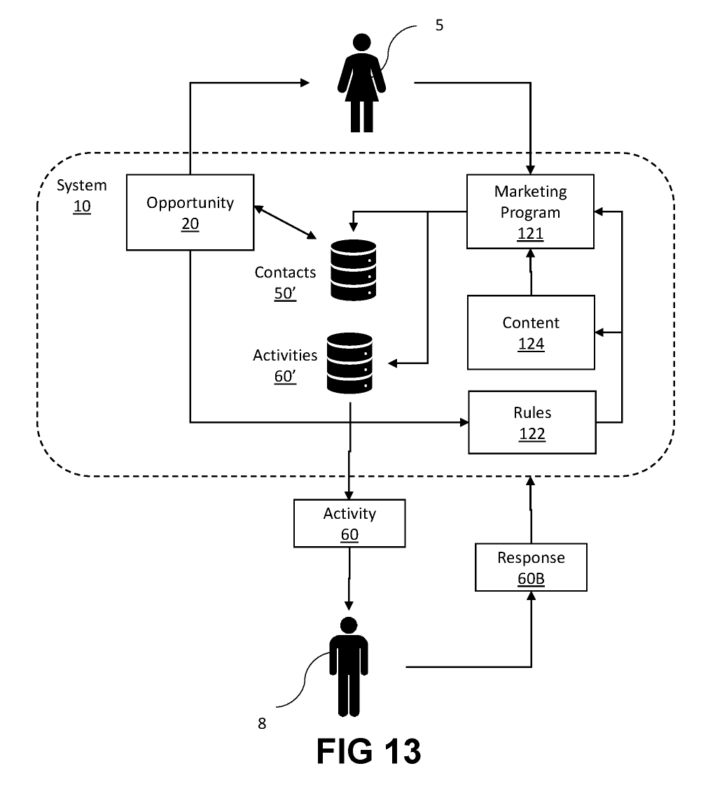

FIG. 13 shows the process used once opportunity 20 is delivered to system 10 and routed to seller 5 by matching attributes of opportunity 20 to goal 30. Attributes of opportunity 20, and via processing of code 92, applies a group of rules 122 that enables an optimized marketing program 121 to be chosen. Rules 122 may control which version, or versions, of marketing program 121 are available for seller 5 to influence contact 8. Rules 122 may control which version, or versions, of an amount of content 124 is available to marketing program 121. For instance, if opportunity 20 has a value of “auto” for product attribute 22, rules 122 may only make emails, postcards, and text messages that are predesignated for use with “auto” opportunities via marketing program 121. Additionally, rules 122 may only make marketing programs available that have a probability of a favorable outcome, or contain content that applies to the source company (company 11). Ultimately and through system 10, seller 5 chooses a version of marketing program 121 which contains a template of one or more activities in sequence. Marketing program 121 then creates one or more rows of records within activity table 60′ for contact 8. Activities within activity table 60′ are considered scheduled, and system 10 delivers or instructs seller 5 to perform activity 60 at the scheduled time. Response 60B is returned to system 10 and the information is made available to seller 5.

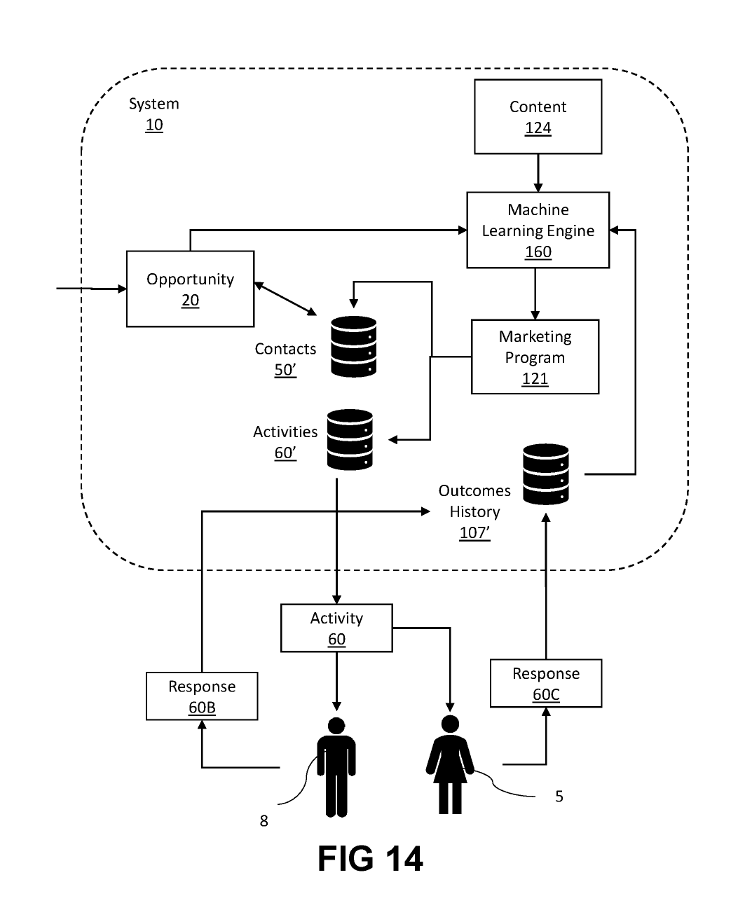

Machine learning can more optimally create marketing plan 121 over manual selection by seller 5. FIG. 14 shows a machine learning version of scheduling activities within activity table 60′. Similar to the above preceding description with respect to FIG. 13, a machine learning engine 160 optimally constructs marketing program 121 based upon attributes of opportunity 20 and a outcomes history 107′. Response 60B of consumer 8, along with feedback response 60C of seller 5 are inputs to outcome history 107′. Machine learning engine 160 may optimally construct marketing program 121 for attributes of seller 5 selling to consumer 8, and for an opportunity 20 having values for attributes 21-29. The goal is for machine learning engine 160 to deliver the version of content 124 with the right type 65 of activity 60 at the right time to engage consumer 8.

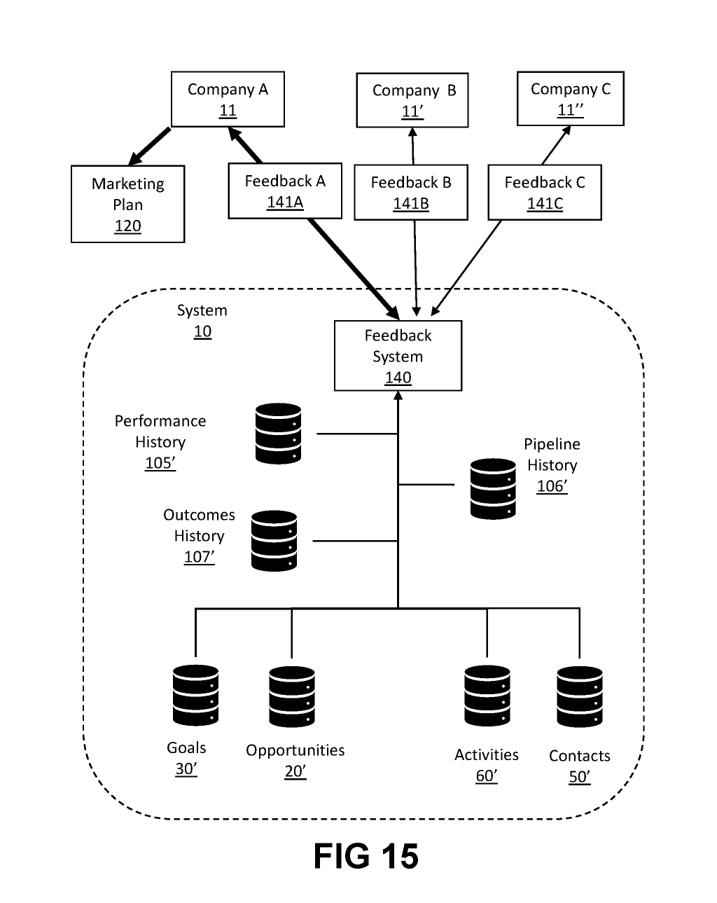

System 10 provides meaningful feedback to sources of opportunities. As shown in FIG. 15, a feedback system 140 aggregates data from performance history 105′, outcomes history 107′, pipeline history 106′, goals table 30′, opportunities table 20′, activities table 60′, and contact table 50′, and selectively makes this data available to companies associated to system 10. For example, if company 11 delivers opportunity 20 to system 10, an amount of feedback 141 may be returned. Feedback 141A may include, but is not limited to, which seller or agency is selling the opportunity, the activity that is or has been performed, which content was used for each activity, and the current stage of the opportunity. Company 11′, and in the event it did not deliver opportunity 20 but was the winner of the sales opportunity, feedback system 140 may deliver back a feedback data 141B comprised of, but not limited to, which seller or agency made the sale, the source of the opportunity, and that company 11′ did not generate opportunity 20 which resulted in the sale. Third company 11″, in the event it did not create opportunity 20 or win the sale, feedback system 140 may provide a feedback 141C indicating that a sale happened in a generalized geography for a particular product attribute, but no additional data. Feedback system 140 provides the means to variably deliver feedback and data from system 10 to one or more companies based upon attributes 21-29 of opportunity 20. Companies 11, 11′ and 11″ may then use feedback 141A-C to more optimally create their own marketing plan 120, to create more effective content 124, more effective versions of marketing program 121, and to better route opportunity 20 to prospective agencies and sellers which operate as separate business to companies 11, 11′ and 11″. The resulting solution of the present invention enables agency accounts to deliver some controlled data to company accounts for the benefit of both, without losing the ability to operate as a separate company.

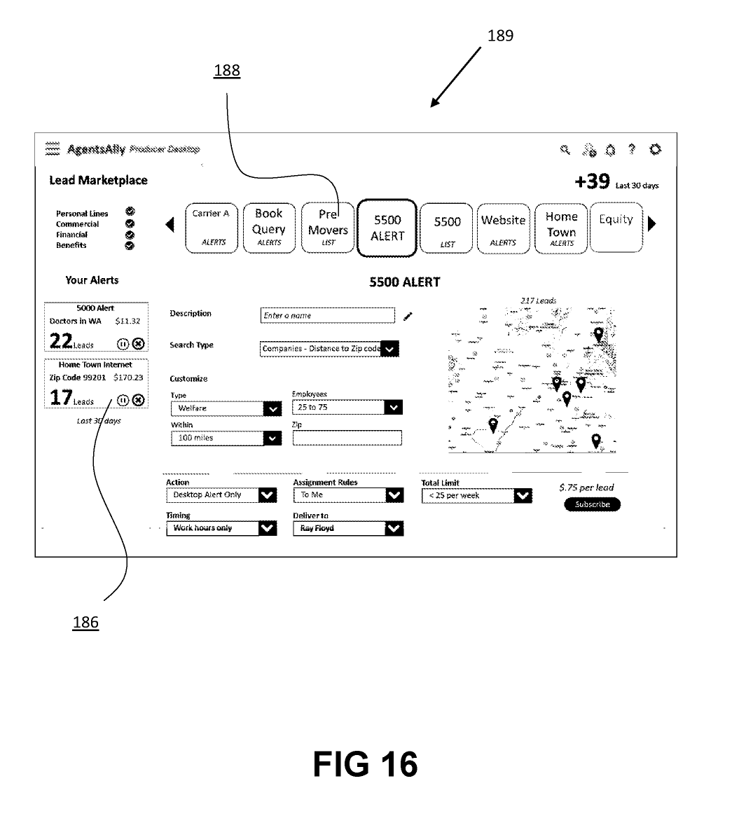

To better understand and appreciate the present invention, examples of display screen 89 are shown in FIGS. 16 to 20.

FIG. 16 shows an example opportunity generation version 189 of screen 89 wherein a user may perform purchase step 140. A list of opportunity sources are shown in source panel 188. The user may configure which type of opportunities they wish to generate based upon the attributes of their own respective goal 30. A list of active or suggested sources is shown in active sources panel 186.

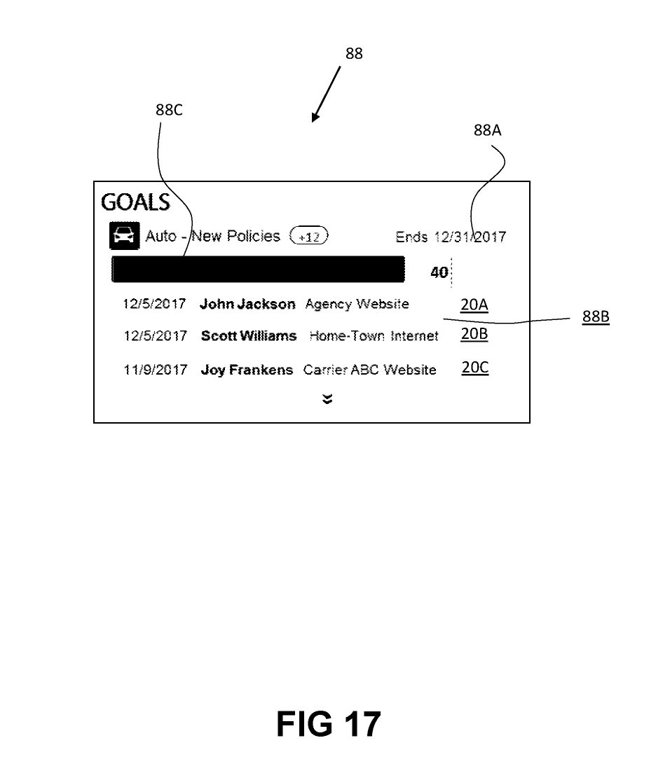

A goal panel 88 is shown in FIG. 17 for displaying goal 30. An attribute section 88A shows one or more goal attributes 32-38. A progress bar 88C is generated by system 10 to show to the user how they are performing to goal 30. An opportunity section 88B displays a first opportunity 20A, a second opportunity 20B, and a third opportunity 20C all of which have one or more opportunity attributes 21-29 that match with goal attributes 32-38. Goal panel 88 provides the means to visually display opportunities with opportunity table 20′ that can help seller 5 meet or exceed goal 30.

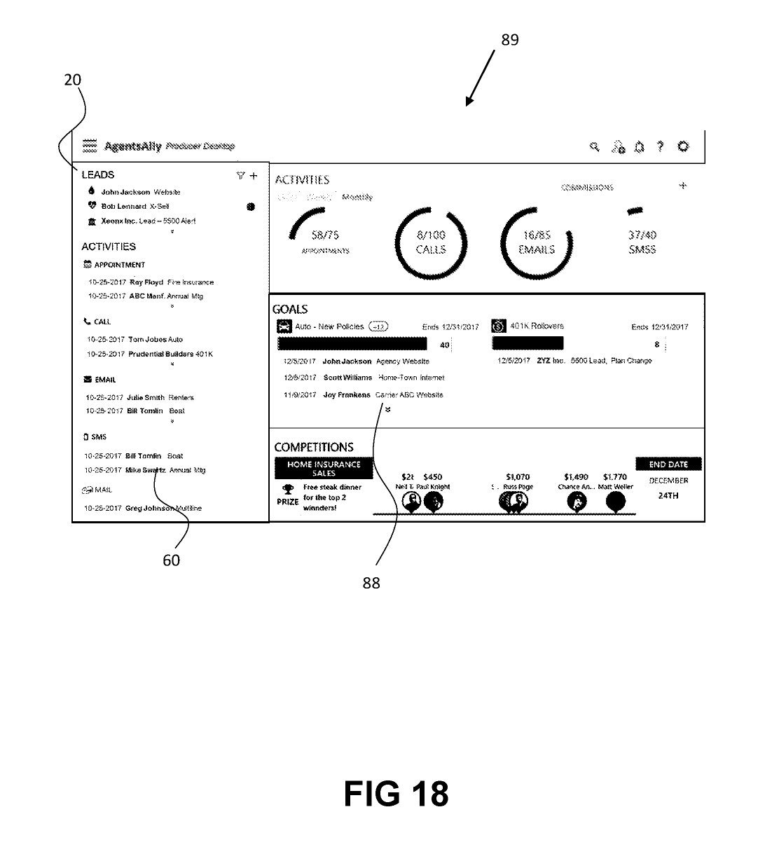

A seller screen 89 is show in FIG. 18 which displays at least one opportunity 20, at least one activity 60 and at least one goal panel 88. Seller screen 89 provides the means to enable sellers to know what to do next.

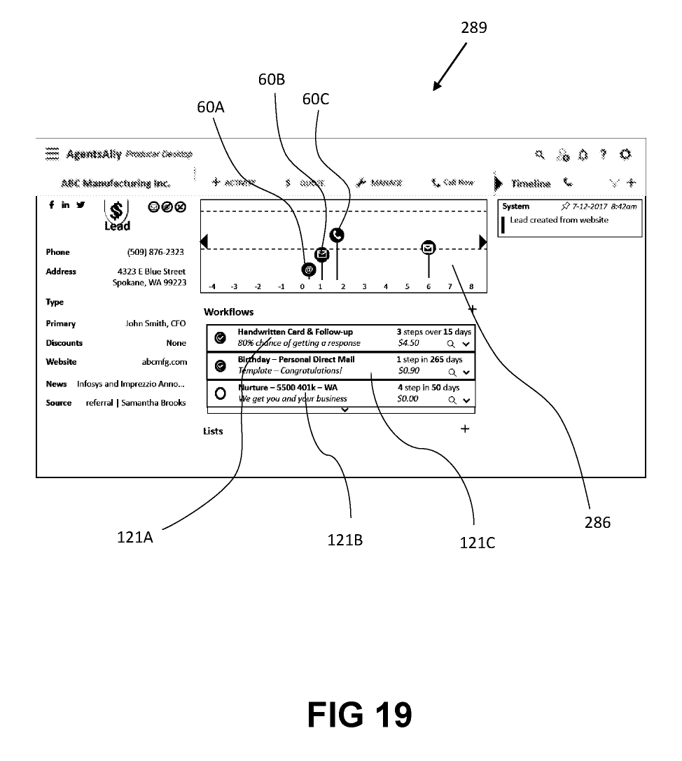

A marketing screen 289 is shown in FIG. 19 and displays how seller 5 may apply an optimal marketing program 121 to contact 40 (representing consumer 8). A timeline panel 286 shows a first activity 60A, a second activity 60B and a third activity 60C that results from the user selecting one or more of a first marketing program 121A, a second marketing program 121B or a third marketing program 121B. Selecting a marketing program 121A-B results in activities 60A-B being scheduled and shown in timeline panel 286B. Marketing programs 121A-B, may be suggested by system 10 as previously described. Marketing screen 289 provides the means for a user to apply marketing program 121 and have one or more activity records created within activity table 60′.

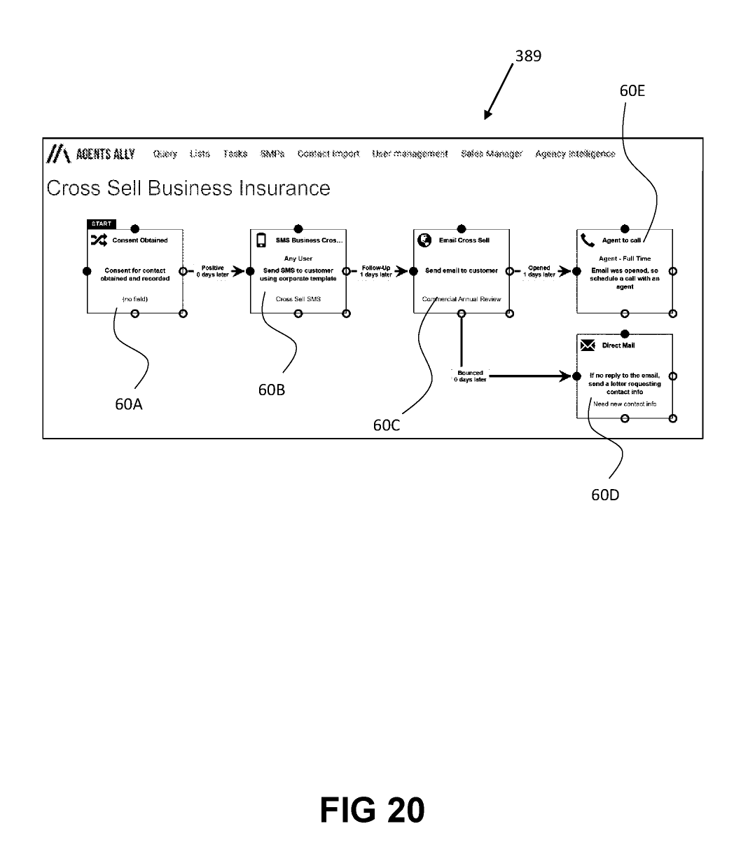

FIG. 20 shows an alternative embodiment marketing program 121 wherein multiple activities may be coordinated with logic utilizing feedback. Activity 60A is delivered to contact 8. After some predetermined amount of time, a second activity 60B is sent to contact 8. A third activity 60C is sent and based upon feedback response 60B, system 10 may instructed by code 92 to send either activity 60E or 60D. FIG. 20 is intended to show that the present invention is not limited to any particular marketing program 121.

While the goal based sales opportunity delivery system herein described constitute preferred embodiments of the invention, it is to be understood that the invention is not limited to these precise form of assemblies, and that changes may be made therein with out departing from the scope and spirit of the invention.

We claim:

1. A computer-implemented method of managing sales opportunities, comprising:
a first seller within a first agency, said first seller having a first goal comprised of an amount of first goal attributes,
a second seller within a second agency, said second seller having a second goal comprised of an amount of second goal attributes;
sending said first goal and said second goal to a first company and a second company, wherein said first company and said second company then advertise to a plurality of potential buyers;
said first company generates an opportunity having at least one opportunity attribute;
matching said at least one opportunity attribute to said amount of first goal attributes of said first seller and routing said opportunity to said first seller;
said first seller performing at least one sales activity in response to receiving said opportunity and generating an amount of opportunity data; and,
said first company receiving a first portion of said amount of opportunity data and said second company receiving a second portion of said amount of opportunity data.

2. The method of claim 1, wherein said matching step includes comparing said opportunity to a set of existing contacts.

3. The method of claim 1, wherein said first company receives a forecast comprised of said first goal and said second goal.

4. The method of claim 1, wherein said first company receives a marketing plan comprised of said first goal and said second goal.

5. The method of claim 1, wherein said opportunity attribute is a type of product.

6. The method of claim 1, wherein after receiving said opportunity said first seller selects a marketing program having a plurality of sales activities.

7. The method of claim 1, wherein said first seller receives a recommended marketing plan from said first company.

8. A computer-implemented method of managing sales opportunities, comprising:
a first seller within a first agency, said first seller creating a first goal comprised of an amount of first goal attributes,
a second seller within a second agency, said second seller creating a second goal comprised of an amount of second goal attributes;
a third seller within a third agency, said third seller creating a third goal comprised of an amount of third goal attributes;
sending said first goal, said second goal and said third goal to a first company and a second company, wherein said first company and said second company advertise to a plurality of potential buyers;
said first company generates an opportunity having at least one opportunity attribute;
matching said at least one opportunity attribute to said amount of first goal attributes of said first seller and to said amount of second goal attributes of said second seller and routing said opportunity to said first seller and said second seller and not routing said opportunity to said third seller;
said first seller and said second seller performing at least one sales activity in response to receiving said opportunity and generating an amount of opportunity data; and,
said first company receiving a first portion of said amount of opportunity data, said second company receiving a second portion of said amount of opportunity data, and a third company receiving a third portion of said amount of opportunity data.

9. The method of claim 8, wherein said matching step includes comparing said opportunity to a set of existing contacts.

10. The method of claim 8, wherein said first company receives a forecast comprised of said first goal, said second goal and said third goal.

11. The method of claim 8, wherein said first company receives a marketing plan comprised of said first goal, said second goal and said third goal.

12. The method of claim 8, wherein said first company receives a financial plan comprised of said first goal, said second goal and said third goal.

13. The method of claim 8, wherein after receiving said opportunity said first seller and said second seller selects a marketing program having a plurality of sales activities.

14. The method of claim 8, wherein said first seller and said second seller each receives a recommended marketing plan from said first company.

15. A computer-implemented method of managing sales opportunities, comprising:
a group of first sellers within a first agency, said first agency having a first goal comprised of an amount of first goal attributes,
a group of second sellers within a second agency, said second agency having a second goal comprised of an amount of second goal attributes;
making available said first goal and said second goal to a first company, a second company, and a third company wherein said first company, said second company and said third company then advertise to a plurality of potential buyers;
said first company generates an opportunity having at least one opportunity attribute;
matching said at least one opportunity attribute to said amount of first goal attributes and routing said opportunity to said first agency;
said first sellers performing at least one sales activity in response to receiving said opportunity and generating an amount of opportunity data; and,
said first company receiving a first portion of said amount of opportunity data, said second company receiving a second portion of said amount of opportunity data, and said third company receiving a third portion of said amount of opportunity data.

16. The method of claim 15, wherein said matching step includes comparing said opportunity to a set of existing contacts.

17. The method of claim 15, wherein said first portion includes a name of a contact.

18. The method of claim 15, wherein said first portion includes an opportunity stage value.

19. The method of claim 15, wherein said first portion, said second portion, and said third portion includes a product type.

20. The method of claim 15, wherein said first portion includes a vendor name.
